(19) United States
(12) Patent Application Publication
(10) Pub. No.: US 2021/0354821 A1
(43) Pub. Date: Nov. 18, 2021

(54) Flying Apparatus

(71) Applicant: Leonardo MW Ltd, Basildon, Essex (GB)

(72) Inventor: Adrian Smith, Basildon, Essex (GB)

(21) Appl. No.: 17/278,409

(22) PCT Filed: Sep. 5, 2019
(86) PCT No.: PCT/GB19/52469

§ 371 Date: Mar. 22, 2021

(30) Foreign Application Priority Data
Sep. 24, 2018 (GB) 1815554.9

(51) Int. Cl. B64C 39/02; B64D 27/24; B60L 50/60; B64F 3/02; B64D 5/00; B64F 1/00; G05D 1/04; B60P 3/11; B63B 35/50

(52) U.S. Cl. CPC B64C 39/024; B64C 39/022; B64D 27/24; B60L 50/60; B64F 3/02; B64D 5/00; B64C 2201/042; G05D 1/042; B60P 3/11; B63B 35/50; B60L 2200/10; B64C 2201/027; B64F 1/007

(57) ABSTRACT

An apparatus for permitting a flying vehicle to land on or take off therefrom whilst the apparatus is airborne, the apparatus including:
a surface for supporting the flying vehicle during landing or when taking off;
at least one propulsion device for sustaining flight of the apparatus and for positioning the surface in a desired landing or taking off orientation; and
a link which is connectable at one end to a land- or sea-going vehicle, for tethering the apparatus relative thereto.

The invention relates an apparatus for permitting a flying vehicle to land on or take off therefrom whilst the apparatus is airborne. The invention also relates to a system including such an apparatus and a land- or sea-going vehicle, a method of landing a flying vehicle using such a system, and a method of permitting the taking off of a flying vehicle using such a system.

Flying vehicles, such as aeroplanes and rotorcraft, and in particular unmanned aerial vehicles (UAVs) and those aircraft capable of vertical take offs and landings (VTOL), are used in a variety of different situations. They have proven useful in reconnaissance for gathering intelligence about an area in which they are deployed and have enhanced a user's strategic capability and situational awareness.

There are three aspects to any flight of a flying vehicle. These three aspects are taking off, sustaining flight and landing. In two of these aspects, taking off and landing, the flying vehicle contacts a surface on which to take off from or land. Thus, these can often be the most dangerous aspects of flying, as there is a smaller margin for error.

According to a first aspect of the invention we provide an apparatus for permitting a flying vehicle to land on or take off therefrom whilst the apparatus is airborne, the apparatus including:
a surface for supporting the flying vehicle during landing or when taking off;
at least one propulsion device for sustaining flight of the apparatus and for positioning the surface in a desired landing or taking off orientation; and
a link which is connectable at one end to a land- or sea-going vehicle, for tethering the apparatus relative thereto.

The link may be releasably attachable to the apparatus.

The link may be directly connected with the apparatus.

The apparatus may include a communication device for communication with the land- or sea-going vehicle.

The communication device may communicate via the link.

The link may be capable of providing power to the apparatus from a power source on the land- or sea-going vehicle.

The apparatus may include a battery for providing power to the propulsion device.

The link may be capable of charging the battery of the apparatus.

The apparatus may include a holding device for holding the flying vehicle relative to the surface.

The holding device may be a projection formation which in use engages with a complementary recess on the flying vehicle; or the holding device may be a recess which in use engages with a complementary projection formation on the flying vehicle.

The holding device may include one or more magnetic devices for magnetically attaching to a magnetically susceptible member of the flying vehicle; or wherein the holding device includes a magnetically susceptible member for magnetically attaching to one or more magnetic devices of the flying vehicle.

The apparatus may include a positioning device which operates intermittently for fine positioning of the surface in a desired landing or take off orientation.

The apparatus may include at least one aerofoil for providing lift to the apparatus.

According to a second aspect of the present invention we provide a system including:
an apparatus in accordance with a first aspect of the invention; and
a land- or sea-going vehicle,
wherein the link may be connected between the apparatus and the land- or sea-going vehicle, tethering the apparatus relative thereto, such that the position of the apparatus relative to the land- or sea-going vehicle may be controllable.

The link may be releasably attachable to the land- or sea-going vehicle.

The link may be capable of being drawn in and/or paid out by a device provided on or by the land- or sea-going vehicle.

The system may include a further link which is connectable at one end to the land- or sea-going vehicle, for tethering the apparatus relative thereto.

The system may include a flying vehicle capable of landing on or taking off from the apparatus.

According to a third aspect of the invention we provide a method of landing a flying vehicle using a system in accordance with the second aspect of the invention, the method including the steps of:
providing the apparatus with the link thereof connected to the apparatus and to the land- or sea-going vehicle;
operating the at least one propulsion device so as to initiate flight of the apparatus away from the land- or sea-going vehicle, and so as to position the apparatus in an airborne position;
positioning the surface of the apparatus in a desired landing orientation; operating the flying vehicle so as to land the flying vehicle on the surface of the apparatus;
adjusting the propulsion of the at least one propulsion device so as to move the apparatus towards the land- or sea-going vehicle; and
landing the apparatus, together with the flying vehicle supported thereon, on a surface of the land- or sea-going vehicle.

According to a fourth aspect of the invention we provide a method of permitting the taking off of a flying vehicle using a system in accordance with the second aspect of the invention, the method including the steps of:
providing the apparatus with the link thereof connected to the apparatus and to the land- or sea-going vehicle;
providing the flying vehicle on the surface of the apparatus;
operating the at least one propulsion device so as to initiate flight of the apparatus away from the land- or sea-going vehicle, and so as to position the apparatus in an airborne position;
positioning the surface of the apparatus in a desired orientation for permitting the taking off of the flying vehicle; and
operating the flying vehicle such that the flying vehicle takes off from the surface of the apparatus.

The method may further including the steps of:
adjusting the propulsion of the at least one propulsion device so as to move the apparatus towards the land- or sea-going vehicle; and
landing the apparatus on a surface of the land- or sea-going vehicle.

The method may further include the step of paying out the link as the apparatus moves away from the land- or sea-going vehicle.

The method may further include the step of drawing in the link as the apparatus moves towards the land- or sea-going vehicle.

As the apparatus moves towards the land- or sea-going vehicle the propulsion of the propulsion device may be adjusted so as to exert no force on the link.

As the apparatus moves towards the land- or sea-going vehicle the propulsion of the propulsion device may be adjusted so as to exert a force on the link to maintain a set distance between the apparatus and the land- or sea-going vehicle.

These and other features of the invention will now be described, by way of example only, with reference to the accompanying figures of which:

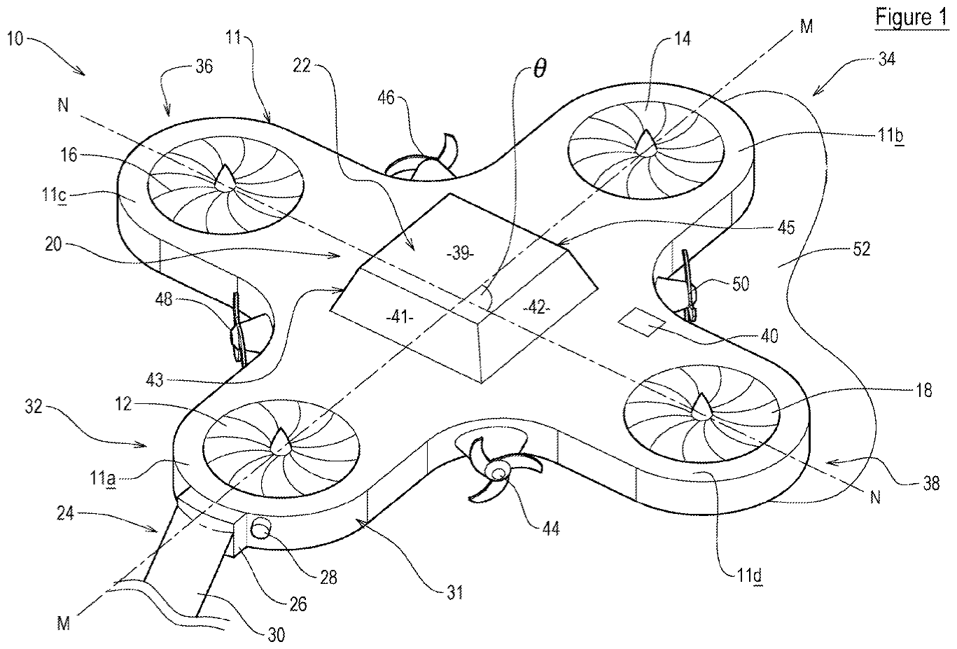

FIG. 1 is a perspective view of an apparatus in accordance with the present invention; and

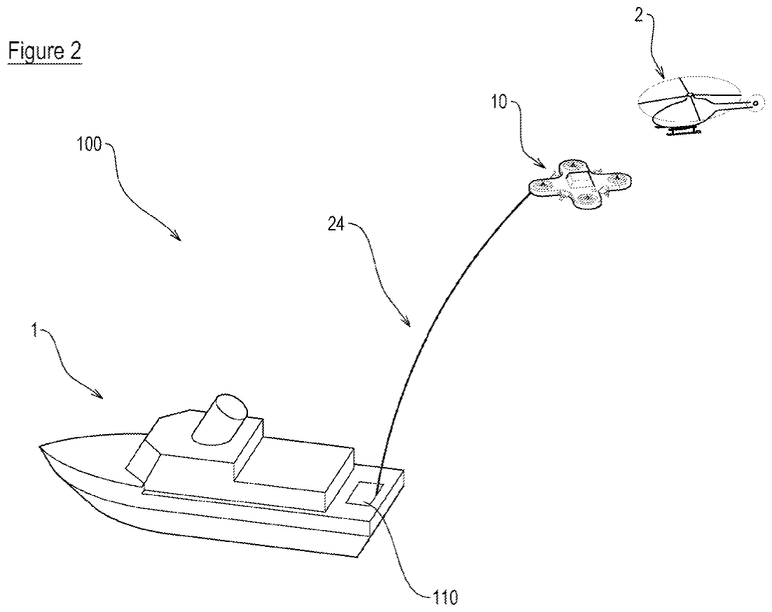

FIG. 2 is a perspective view of a system in accordance with the present invention with a flying vehicle in mid-flight;

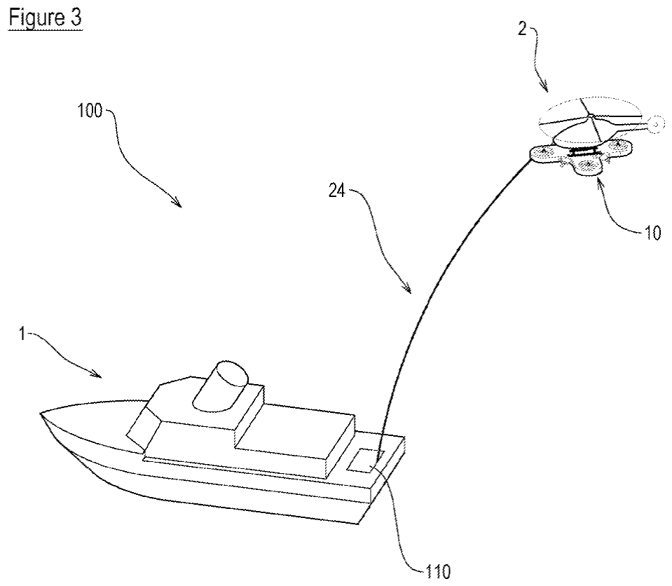

FIG. 3 is a perspective view of the system of FIG. 2 with the flying vehicle supported on the apparatus; and

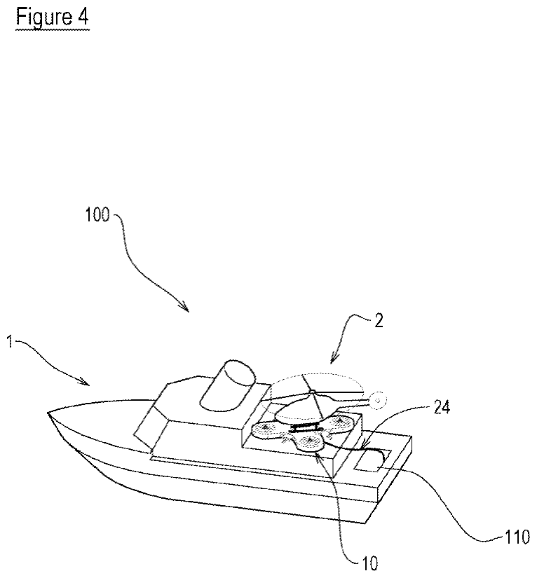

FIG. 4 is a perspective view of the system of FIG. 2 with the flying vehicle supported on the apparatus and both the flying vehicle and apparatus resting on a land- or sea-going vehicle.

Referring to the figures, there is shown an apparatus 10 and a system 100 in accordance with the present invention.

The apparatus 10 is capable of becoming airborne and is provided with at least one propulsion device 12, 14, 16, 18 for sustaining flight of the apparatus 10. In the present embodiment four propulsion devices in the form of four rotors 12, 14, 16, 18 are provided which are capable of maintaining the apparatus 10 in an airborne position. In other words, the rotors 12, 14, 16, 18 provide lift to the apparatus 10.

A body 11 of the apparatus 10 is generally cross-shaped in plan view and thus has four body portions 11a, 11b, 11c, 11d which extend outwardly away from each other to form the cross-shape. The body portions 11a, 11b, 11c, 11d each terminate at a free end which supports, in a respective aperture, a respective one of the rotors 12, 14, 16, 18. A terminating edge portion of each free is curved in such a way that it generally follows the curvature of the aperture in which the rotor 12, 14, 16, 18 is supported. However, it should be appreciated that the terminating edge portions need not necessarily be curved. The body 11 is, with the exception of a projection formation 22 (discussed later), of a generally uniform thickness, but it need not be.

The apparatus 10 has a surface 20 for supporting a flying vehicle 2, for example an unmanned aerial vehicle (UAV), during landing or when taking off. The surface 20 is positioned generally centrally of the four body portions 11a, 11b, 11c, 11d. It should be appreciated that whilst the present example is intended for use with a UAV, it could also be used with other aircraft capable of vertical take offs and landings (VTOL), such as helicopters and planes having VTOL capability.

The rotors 12, 14, 16, 18 each have a fixed rotational axis which is generally vertical, i.e. perpendicular to a plane in which the body 11 and/or the surface lies. However, it should be appreciated that the rotational axes of the rotors 12, 14, 16, 18 need not necessarily be vertical, and could alternatively be inclined at an angle to a plane in which the body 11 and/or surface 20 lies without departing from the scope of the present invention. Indeed, in other envisaged embodiments the rotors 12, 14, 16, 18 may be, e.g. rotatably, movable relative to the body 11 so as to alter the orientation of the rotational axes of the rotors 12, 14, 16, 18.

The rotors 12, 14, 16, 18 are also capable of positioning the surface 20 in a desired landing or take off orientation for the flying vehicle 2. In the present embodiment, the rotors 12, 14, 16, 18 position the surface 20 in a generally horizontal plane. This is advantageous because the surface 20 is maintained in a stable position, and thus is able to provide a stable reference point whilst airborne.

When a flying vehicle 2 is landing on or taking off from the apparatus 10 a controller (not shown) is configured to monitor the change in position of the apparatus 10 and adjust the lift provided by the rotors to account for the change in weight acting on the apparatus 10. For example, when a flying vehicle 2 lands on the apparatus 10 the controller increases the thrust produced by the rotors 12, 14, 16, 18 to account for the increase in weight acting on the apparatus 10. Conversely, when a flying vehicle 2 takes off from the apparatus 10 the controller reduces the thrust produced by the rotors 12, 14, 16, 18 to account for the decrease in weight acting on the apparatus 10. Force sensors may be provided on the surface 20 to determine how much to increase or decrease the thrust provided and how fast or slow the increase or decrease in thrust is changed.

It should be appreciated that in other embodiments of the invention more or fewer than four rotors may be provided without departing from the scope of the present invention.

It should also be appreciated that whilst in the embodiment shown the at least one propulsion device is provided as four rotors alterative propulsion devices could be used without departing from the scope of the present invention.

The apparatus 10 has a link 24 which is connectable at one end to a land- or sea-going vehicle 1, shown as part of system 100 of FIG. 2. The link 24 tethers the apparatus 10 to the land- or sea-going vehicle 1. In the present embodiment the link 24 is provided on a side 31 of the apparatus 10 which is generally positioned at a front 32 of the apparatus 10, i.e. in a generally forward position with respect to a flight path of the apparatus 10. In other embodiments, however, the link 24 may be attached elsewhere to the body 11 of the apparatus 10. For example, the link 24 may be attached to a downwardly facing surface of the apparatus 10. Alternatively still, multiple links 24 may be attached to the sides and/or the bottom of the apparatus 10 without departing from the scope of the present invention. In flight the rotor 12 is generally positioned at the fore or front 32 of the apparatus 10 with respect to an intended flight path of the apparatus 10, behind the link 24, and the rotor 14 is generally positioned at the aft or rear 34 of the apparatus 10 with respect to the intended flight path of the apparatus 10, i.e. generally opposite the rotor 12 at the front 32 of the apparatus 10. The rotors 16, 18 are then positioned laterally to either side of the rotors 12, 14 in flight. In particular, the rotational axes of the rotors 12, 14 lie in a vertical plane M and the rotors 16, 18 are positioned laterally to either side of the plane M on respective first and second sides 36, 38 of the apparatus 10. However, in an alternative embodiment the fore or front 32 of the apparatus may be positioned in-between the rotors 12, 16 with respect to an intended flight path of the apparatus 10 and the aft or rear 34 of the apparatus may be positioned in-between the rotors 14, 18. In this alternative embodiment the rotors 12, 14, 16, 18 may lie either side of a generally vertical plane in which the fore, or front, 32 and aft, or rear, 34 of the apparatus 10 lie.

The rotational axes of the rotors 16, 18 lie in a vertical plane N which bisects the plane M. In particular, the plane N is generally perpendicular to the plane M. Alternatively, the plane N may be inclined at an angle θ to the plane M without departing from the scope of the present invention. The apparatus 10 is generally symmetrical about plane M. The apparatus 10 is also generally symmetrical about plane N.

In the present embodiment the link 24 includes an attachment device 26, a release button 28 and a tether 30. The link 24 is releasably attachable to the apparatus 10. The attachment device 26 on the apparatus 10 releasably attaches the tether 30 to the apparatus 10. The release button 28 is operatively connected to the attachment device 26 for manually releasing the tether 30 from the attachment device 26 and thus the apparatus 10.

The attachment device 26 may be controllable by the controller of the apparatus 10 or of the land- or sea-going vehicle 1 once a predetermined condition, or predetermined conditions, has been met. Examples of a predetermined condition may be if adverse flying conditions are detected, or if it is detected that the tether has become damaged or entangled in the land- or sea-going vehicle 1 or another body. The predetermined condition may be detected by the apparatus 10 or the land- or sea-going vehicle 1. If the predetermined condition is met then the controller will instruct the attachment device 26 to release the tether 30.

In alternative embodiments the link 24 may be directly connected to the apparatus 10.

The apparatus 10 has a communication device 40 for communication with a land- or sea-going vehicle 1. In this particular embodiment the communication device communicates with the land- or sea-going vehicle 1 via the link 24. However, the communication device 40 may alternatively, or additionally, communicate wirelessly with the land- or sea-going vehicle 1.

In the present embodiment the apparatus 10 has a battery (not shown) which powers the rotors 12, 14, 16, 18. The battery has sufficient capacity to provide power to the rotors 12, 14, 16, 18 for a desired period of time, e.g. up to 30 minutes. This is advantageous because if the link 24, in particular the tether 30, needs to be jettisoned, for instance if it becomes damaged or entangled, then the apparatus 10 is capable of landing on the land- or sea-going vehicle 1 using power drawn only from its battery.

The link 24 is capable of providing power to the apparatus 10 from a power source on the land- or sea-going vehicle 1. In particular, the battery of the apparatus 10 is chargeable via the link 24 by a power source on the land- or sea-going vehicle 1. In the present embodiment the apparatus 10, when tethered, may rely solely on the power provided through the link 24 to power the rotors 12, 14, 16, 18. However, in other envisaged embodiments the apparatus 10 may draw power from the battery whilst it is connected to the link 24 and the link 24 may continuously charge the battery via the power source on the land- or sea-going vehicle 1. In other further envisaged embodiments the apparatus 10 may draw power from both the battery and the power provided through the link 24.

As mentioned above, the apparatus 10 has a surface 20 which, in use, supports a flying vehicle 2 during landing or when taking off. In the present embodiment the surface 20 is configured for supporting an unmanned helicopter, though it should be appreciated that the surface could be configured to support other types of flying vehicle. For instance, the surface could be configured to support aircraft capable of vertical take offs and landings (VTOL), such as a manned helicopter or a plane capable of VTOL, or it could alternatively be configured as a runway without departing from the scope of the present invention.

A holding device in the form of a projection formation 22 is provided on the surface 20. This projection formation 22 holds the flying vehicle 2 relative to the surface 20. The projection formation 22 in use abuts a complementary recess on the flying vehicle 2 once the flying vehicle 2 has landed or before the flying vehicle 2 takes off. This ensures that the flying vehicle 2 is in the correction position and orientation for the apparatus 10 to be able to manoeuvre correctly when the flying vehicle 2 is supported on the surface 20 and for the flying vehicle 2 to be able to land and take off from the surface 20 correctly and accurately.

It should be appreciated that the projection formation could, alternatively, be provided on the flying vehicle 2 and the recess could be provided on the surface 20 without departing from the scope of the present invention.

In the present embodiment, the projection formation 22 decreases in width and height as it extends away from the surface 20. In particular, the projection formation 22 is a truncated four-sided pyramid, the centre of which lies at the intersection between planes M and N, and is configured for supporting a helicopter with a skid undercarriage. This is advantageous because the shape of the projection formation 22 guides the flying vehicle 2 into the correct position on the surface 20 to ensure the weight of the flying vehicle 2 is correctly distributed across the apparatus 10. However, this should not be taken to be limiting and various other projection formations are envisaged which are configured to support other types of undercarriage and guide a flying vehicle into the correct position on the surface.

The holding device may alternatively, or additionally, be provided as one or more magnetic devices for magnetically attaching to a magnetically susceptible member on the flying vehicle 2. This may ensure that the flying vehicle 2 is held in the correct position on the surface 20. Alternatively, the holding device may be a magnetically susceptible member on the apparatus for magnetically attaching to one or more magnetic devices on the flying vehicle 2.

The projection formation 22 has a top surface 39 which is generally rectangular and side surfaces 41, 42, 43, 45 which are generally trapezoidal. The top surface 39 and/or the side surfaces 41, 42, 43, 45 may have a relatively high coefficient of friction. This assists the top surface 39 and/or the side surfaces 41, 42, 43, 45 in maintaining the flying vehicle 2 in the correct position relative to the surface 20 for instance if there are adverse weather conditions which may cause the flying vehicle 2 to move relative to the surface before take-off or once the flying vehicle 2 has landed.

The apparatus 10 may also has one or more positioning devices. In the present embodiment the apparatus 10 has four positioning devices 44, 46, 48, 50. The optional positioning devices 44, 46, 48, 50 permit fine positioning of the surface 20 in a desired landing or take off orientation once the rotors 12, 14, 16, 18 have positioned the surface 20 in generally the right orientation for landing or take off. The positioning devices 44, 46, 48, 50 may, in particular, be able to counteract displacement of the apparatus 10 from a desired position due to gusts of wind or the like. Thus, the positioning devices 44, 46, 48, 50 are only used if a minor adjustment to the position of the surface 20 is required. In other words, the positioning devices 44, 46, 48, 50 only operate for short periods of time compared to the rotors 12, 14, 16, 18, i.e. they may operate intermittently. Otherwise, the positioning devices 44, 46, 48, 50 may be inactive. It should be appreciated, however, that the positioning devices 44, 46, 48, 50 are not essential and that the rotors 12, 14, 16, 18 themselves may be capable of providing fine positioning of the surface 20 in a desired landing or take off orientation in isolation.

The four positioning devices 44, 46, 48, 50 in the present embodiment are fans, though it should be appreciated that any other suitable device may be used. For instance, additional rotors oriented perpendicular, or parallel or at an angle relative to the rotational axes of the rotors 12, 14, 16, 18 may be used instead of, or as well as, fans.

In an alternative embodiment one or more motors may be attached, directly or indirectly via a linkage and/or gearing between the body 11 and the surface 20, to the surface 20 and be controllable by the controller. The controller may be configured to provide fine control of the motors, linkage and thus the gearing (if present) for permitting fine positioning of the surface 20 in a desired landing or take off orientation relative to the body 11. In effect, the one or more motors, linkage and/or gearing and controller may function as a gimbal to maintain the surface 20 in a desired landing or take off orientation once the one or more propulsion devices 12, 14, 16, 18 have positioned the surface 20 in generally the right orientation. This configuration of motors, linkage and/or gearing and controller may be used in conjunction with the positioning devices described above.

The apparatus 10 may be provided with sensors to provide information about the surrounding environment. For instance, the apparatus 10 may include a radar receiver for providing an extended range for the land- or sea going vehicle 1. The radar may be protected by a radome which in the embodiment shown is provided as an inflatable tube 52. The apparatus 10 may also include a radio transceiver for providing an extended range for the land- or sea-going vehicle 1. The apparatus 10 may also include a camera for providing an extended field of view for the land- or sea going vehicle 1. The apparatus 10 may also include an infra-red sensor for providing thermal imaging and/or night vision for the land- or sea-going vehicle 1. The apparatus may also be provided with a sensor for monitoring wind speed and direction. The apparatus 10 may provide this information to the land- or sea-going vehicle 1 wirelessly or via the link 24. Thus the apparatus 10 acts as a surveillance apparatus in addition to functioning as an apparatus on which a flying vehicle 2 may land on and take off from, and provides an airborne early warning for the land- or sea-going vehicle 1.

The apparatus 10 may be provided with one or more aerofoils (not shown) for providing lift to the apparatus 10. For example, the one or more aerofoils may each take the form of a fixed aircraft wing. This is advantageous as it enables the apparatus to take advantage of any wind, either environmental or as a by-product of the land- or sea-going vehicle 1 moving, and reduce the rotors' 12, 14, 16, 18 power consumption. In the present embodiment at least part of the one or more aerofoils is provided as part of the inflatable tube 52. The inflatable tube is also advantageous as, if the apparatus 10 is ditched in the sea, the inflatable tube 52 provides positive buoyancy so the apparatus 10 will float. This enables the apparatus 10 to be easily recovered.

The apparatus 10 may also be provided with a visual indicator device for assisting in guiding the flying vehicle towards or away from the surface 20, for instance during bad weather. The visual indicator device may include a symbol, such as an “H”, on the surface 20 of the apparatus 10. The visual indicator device may also include lights which indicate the position and orientation of the surface 20. This may be advantageous in enabling a determination of whether or not it is possible for the flying vehicle 2 to land on the surface 20.

The apparatus may be designed using stealth technology. For instance, the body 11 of the apparatus 10 may be made from non-metallic materials or non-metallic composites. In particular, the body 11 may be made from a radar-absorbing material, or may be coated in a radar-absorbing paint. These materials reduce the electromagnetic (radar/infra-red/visible light) signature of the apparatus 10. Such materials may also be used on the tether 30 to the tether's electromagnetic signature. Such materials are known in the art.

The apparatus 10, and in particular the body 11 of the apparatus 10, may be made using stealth designs. For instance, the shape of the body 11 may be designed to produce a low radar cross-section as is known in the art. In particular, the body 11 may incorporate re-entrant triangles so that radar waves which penetrate the body 11 become trapped, reflect off internal surfaces of the body 11 and lose energy, thus preventing, or substantially reducing, the possibility of the apparatus 10 being detected by radar. The body 11 and/or the one or more aerofoils may also incorporate corner reflectors.

The rotors 12, 14, 16, 18 and/or the positioning devices 44, 46, 48, 50 may use modulated blade spacing, i.e. having varying spaces between blades of the rotors 12, 14, 16, 18 and/or the positioning devices 44, 46, 48, 50, to reduce the noise produced by the rotors 12, 14, 16, 18 and/or the positioning devices 44, 46, 48, 50.

In the present embodiment the apparatus 10 is autonomous and requires no user input to maintain it in an airborne position. The apparatus 10 can also autonomously, or independently, land at and/or take off from a specified position on the land- or sea-going vehicle 1. This is advantageous in the event that the tether 30 needs to be jettisoned and the apparatus 10 needs to land, i.e. be recovered. This may be achieved by using the one or more aerofoils of the apparatus 10 and/or using the rotors 12, 14, 16, 18. Alternatively the apparatus may be controlled by a user. In particular the user may be positioned on the land- or sea-going vehicle 1. The user may provide commands to the communication device 40 of the apparatus 10 through the link 24. Alternatively, the commands may be communicated to the communication device 40 of the apparatus 10 wirelessly. In other embodiments the user may be positioned on a different vehicle to the land- or sea-going vehicle 1, or may be positioned in a building remote from the land- or sea-going vehicle 1.

The apparatus 10 may also incorporate “lighter than air” technology to provide lift or neutral buoyancy to the apparatus 10. For instance, the inflatable tube 52 and/or the body 11 of the apparatus 10 may be filled with hydrogen and/or helium and/or neon and/or ammonia and/or methane to provide lift to the apparatus 10. This may be advantageous in reducing the lift needed to be produced by the rotors 12, 14, 16, 18. In one particular embodiment the inflatable tube and/or the body 11 of the apparatus 10 may include a lighter than air aerogel, such as SEAgel™.

The apparatus 10 may also be able to communicate with the flying vehicle 2 via the communication device 40. The apparatus 10 may provide the flying vehicle 2 with navigational information to assist the flying vehicle 2 in landing on or taking off from the apparatus 10. In particular, the apparatus 10 may be able to communicate with the flying vehicle 2 wirelessly directly or via the land- or sea-going vehicle.

A system 100 is shown in FIGS. 2 to 4 which includes an apparatus 10, as described above, a land- or sea-going vehicle 1, a flying vehicle 2 and a link 24. The link 24 is connected between the apparatus 10 and land- or sea-going vehicle 1, tethering the apparatus 10 relative thereto, such that the position of the apparatus 10 relative to the land- or sea-going vehicle 1 is controllable. The link 24 is releasably attachable to the land- or sea-going vehicle 1 by an attachment device (not shown) similar to the attachment device 26 of the apparatus 10.

The link 24, and in particular the tether 30, is capable of being drawn in and/or paid out by a device 110 provided on or by the land- or sea-going vehicle 1. Alternatively, or in addition, the device 110 may be provided on the apparatus 10.

The system 100 may include a further link (not shown). This is advantageous in the event that the link 24 needs to be jettisoned or becomes damaged because it will still be possible to connect the apparatus 10 to the land- or sea-going vehicle 1.

A method of landing the flying vehicle 2 will now be described, using the system 100. The method includes the initial step of providing the apparatus 10 with the link 24 which is connectable to the apparatus 10 and ensuring that the link 24 is also connected to the land- or sea-going vehicle 1. Once the link 24 is connected between the apparatus 10 and the land- or sea-going vehicle 1 the apparatus 10 is positioned on a surface of the land- or sea-going vehicle 1 ready to take off. The rotors 12, 14, 16, 18 are then operated so as to initiate flight of the apparatus 10 away from the land- or sea-going vehicle 1. The rotors 12, 14, 16, 18 also position the apparatus 10 in an airborne position relative to the land- or sea-going vehicle 1. The method then includes the step of positioning the surface 20 of the apparatus 10 in a desired landing orientation. This includes the step of adjusting the propulsion provided by each of the rotors 12, 14, 16, 18 so as to ensure the surface is in a generally horizontal orientation. The step of positioning the surface may also include the step of providing propulsion from the positioning device(s) or rotors 12, 14, 16, 18 to provide fine positioning of the surface 20 ready for a flying vehicle 2 to land thereon. The flying vehicle 2 is then operated so as to land the flying vehicle 2 on the surface 20 of the apparatus 10. This may include the step of increasing the propulsion provided by each of the rotors 12, 14, 16, 18 to account for the additional weight of the flying vehicle 2 on the apparatus 10. The propulsion provided by the rotors 12, 14, 16, 16 is then adjusted so as to move the apparatus 10 towards the land- or sea-going vehicle 1. Then, finally, the method includes landing the apparatus 10, together with the flying vehicle 2 supported thereon, on a surface of the land- or sea-going vehicle 1.

A method of permitting the taking off of a flying vehicle 2 will now be described, using the system 100. The method includes the initial step of providing the apparatus 10 with the link 24 which is connectable to the apparatus 10 and ensuring that the link 24 is also connected to the land- or sea-going vehicle 1. Once the link 24 is connected between the apparatus 10 and the land- or sea-going vehicle 1 the flying vehicle 2 is provided on the apparatus 10. This may include ensuring that the holding device 22 is holding the flying vehicle 2 relative to the surface 20. The apparatus 10 and flying vehicle 2 are then positioned on a surface of the land- or sea-going vehicle 1 ready for the apparatus 10 to take off, supporting the flying vehicle 2. The rotors 12, 14, 16, 18 are then operated so as to initiate flight of the apparatus away from the land- or sea-going vehicle 1. The rotors 12, 14, 16, 18 also position the apparatus 10 in an airborne position relative to the land- or sea-going vehicle 1. The method then includes the step of positioning the surface of the apparatus 10 (and thus the vehicle 2) in a desired take off orientation. This includes the step of adjusting the propulsion provided by each of the rotors 12, 14, 16, 18 so as to ensure the surface is in a generally horizontal orientation. The step of positioning the surface may also include the step of providing propulsion from the positioning device(s) to provide fine positioning of the surface 20 ready for the flying vehicle 2 to take off therefrom. The flying vehicle 2 is then operated such that the flying vehicle 2 takes off from the surface 20 of the apparatus 10 in a normal manner. This may include the step of decreasing the propulsion provided by each of the rotors 12, 14, 16, 18 to account for the reduction in weight acting on the apparatus 10 once the flying vehicle 2 takes off. The apparatus 10 may then be returned to the land- or sea-going vehicle 1. This may include the step of the propulsion provided by the rotors 12, 14, 16, 16 being adjusted so as to move the apparatus 10 towards the land- or sea-going vehicle 1. This may also include the step of landing the apparatus 10 on a surface of the land- or sea-going vehicle 1. Alternatively, the apparatus 10 could stay airborne to await landing of the same or a further flying vehicle 2.

Both of the above methods may include the additional step of paying out the link 24, using the device 110, as the apparatus 10 moves away from the land- or sea-going vehicle 1.

Both of the above methods may also include the step of drawing in the link 24, using the device 110, as the apparatus 10 moves towards the land- or sea-going vehicle 1.

As the apparatus 10 moves towards the land- or sea-going vehicle 1 the propulsion of the rotors 12, 14, 16, 18 may be adjusted so as to exert no force on the link 24. This may be advantageous in saving energy in landing the apparatus 10 on the land- or sea-going vehicle 1.

Alternatively, as the apparatus 10 moves towards the land- or sea-going vehicle 1 the propulsion of the rotors 12, 14, 16, 18 may be adjusted so as to exert a force on the link 24. This is advantageous as it maintains a set distance between the apparatus 10 and the land- or sea-going vehicle 1 which is known, and so the position of the apparatus 10 relative to the land- or sea-going vehicle 1 may be more accurately known. In other words, the apparatus may be “hauled down” as it moves towards the land- or sea-going vehicle 1.

Both of the methods above may include the step of jettisoning the tether 30, for example if the tether becomes entangled or damaged.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An apparatus for permitting a flying vehicle to land on or take off therefrom whilst the apparatus is airborne, the apparatus including:
a surface for supporting the flying vehicle during landing or when taking off;
at least one propulsion device for sustaining flight of the apparatus and for positioning the surface in a desired landing or taking off orientation; and
a link which is connectable at one end to a land- or sea-going vehicle, for tethering the apparatus relative thereto.

2. An apparatus according to claim 1 wherein the link is releasably attachable to the apparatus.

3. An apparatus according to claim 1 wherein the link is directly connected with the apparatus.

4. An apparatus according to claim 1 further including a communication device for communication with the land- or sea-going vehicle.

5. An apparatus according to claim 4 wherein the communication device communicates via the link.

6. An apparatus according to claim 1 wherein the link is capable of providing power to the apparatus from a power source on the land- or sea-going vehicle.

7. An apparatus according to claim 1 further including a battery for providing power to the propulsion device.

8. An apparatus according to claim 7 wherein the link is capable of charging the battery of the apparatus.

9. An apparatus according to claim 1 including a holding device for holding the flying vehicle relative to the surface.

10. An apparatus according to claim 9 wherein the holding device is a projection formation which in use engages with a complementary recess on the flying vehicle; or wherein the holding device is a recess which in use engages with a complementary projection formation on the flying vehicle.

11. An apparatus according to claim 9 wherein the holding device includes one or more magnetic devices for magnetically attaching to a magnetically susceptible member of the flying vehicle; or wherein the holding device includes a magnetically susceptible member for magnetically attaching to one or more magnetic devices of the flying vehicle.

12. An apparatus according to claim 1 including a positioning device which operates intermittently for fine positioning of the surface in a desired landing or take off orientation.

13. An apparatus according to claim 1 further including at least one aerofoil for providing lift to the apparatus.

14. A system including:
an apparatus according to claim 1; and
a land- or sea-going vehicle,
wherein the link is connected between the apparatus and the land- or sea-going vehicle, tethering the apparatus relative thereto, such that the position of the apparatus relative to the land- or sea-going vehicle is controllable.

15. A system according to claim 14 wherein the link is releasably attachable to the land- or sea-going vehicle.

16. A system according to claim 14 wherein the link is capable of being drawn in and/or paid out by a device provided on or by the land- or sea-going vehicle.

17. A system according to claim 14 including a further link which is connectable at one end to the land- or sea-going vehicle, for tethering the apparatus relative thereto.

18. A system according to claim 14 further including a flying vehicle capable of landing on or taking off from the apparatus.

19. A method of landing a flying vehicle using the system of claim 14, the method including the steps of:
providing the apparatus with the link thereof connected to the apparatus and to the land- or sea-going vehicle;
operating the at least one propulsion device so as to initiate flight of the apparatus away from the land- or sea-going vehicle, and so as to position the apparatus in an airborne position;
positioning the surface of the apparatus in a desired landing orientation;
operating the flying vehicle so as to land the flying vehicle on the surface of the apparatus;
adjusting the propulsion of the at least one propulsion device so as to move the apparatus towards the land- or sea-going vehicle; and
landing the apparatus, together with the flying vehicle supported thereon, on a surface of the land- or sea-going vehicle.

20. A method of permitting the taking off of a flying vehicle using the system of claim 14, the method including the steps of:
providing the apparatus with the link thereof connected to the apparatus and to the land- or sea-going vehicle;
providing the flying vehicle on the surface of the apparatus;
operating the at least one propulsion device so as to initiate flight of the apparatus away from the land- or sea-going vehicle, and so as to position the apparatus in an airborne position;
positioning the surface of the apparatus in a desired orientation for permitting the taking off of the flying vehicle; and
operating the flying vehicle such that the flying vehicle takes off from the surface of the apparatus.

21. A method according to claim 20 further including the steps of:
adjusting the propulsion of the at least one propulsion device so as to move the apparatus towards the land- or sea-going vehicle; and
landing the apparatus on a surface of the land- or sea-going vehicle.

22. A method according to claim 19 further including the step of paying out the link as the apparatus moves away from the land- or sea-going vehicle.

23. A method according to claim 19 further including the step of drawing in the link as the apparatus moves towards the land- or sea-going vehicle.

24. A method according to claim 23 wherein as the apparatus moves towards the land- or sea-going vehicle the propulsion of the propulsion device is adjusted so as to exert no force on the link.

25. A method according to claim 23 wherein as the apparatus moves towards the land- or sea-going vehicle the propulsion of the propulsion device is adjusted so as to exert a force on the link to maintain a set distance between the apparatus and the land- or sea-going vehicle.
